(19) United States
(12) Patent Application Publication
(10) Pub. No.: US 2013/0286671 A1
(43) Pub. Date: Oct. 31, 2013

(54) ADAPTIVE WORK LIGHT AND DRIVE LIGHT INTENSITY FOR A WORK VEHICLE

(71) Applicants: Scott J Breiner, Dubuque, IA (US); Chris Guillory, Peosta, IA (US); Boyd M. Nichols, Dubuque, IA (US)

(72) Inventors: Scott J Breiner, Dubuque, IA (US); Chris Guillory, Peosta, IA (US); Boyd M. Nichols, Dubuque, IA (US)

(21) Appl. No.: 13/457,909

(22) Filed: Apr. 27, 2012

(51) Int. Cl. B60Q 1/00

(52) U.S. Cl. 362/464

(57) ABSTRACT

A vehicle lighting system in which a controller changes the intensity of a drive light and/or a work light as a function of a speed of the vehicle.

### FIELD OF THE INVENTION

This invention relates to vehicular lighting systems and, in particular, automatically adaptive vehicular lighting systems.

### BACKGROUND OF THE INVENTION

Work lights and drive lights are often used in forestry and other work equipment when operating forestry and other work vehicles under low ambient lighting conditions such as, for example, nighttime. Under such conditions it may be desirable to adjust the intensity of the work and drive lights in accordance with the particular work being done by the vehicle as desirable light intensity may vary with the particular work being done by the work vehicle. For example, a greater intensity may be desired when a log skidder is travelling at a reasonable distance from a landing and at greater speeds than when being operated at the landing where lights of other vehicles and the landing are operating and where reflected light as well as lights from other vehicle may negatively interfere with the vision of the operator(s).

### SUMMARY OF THE INVENTION

The inventors have recognized the value and desirability of adjusting work and drive intensity as vehicle operation changes under low ambient lighting conditions. These light intensities may be adjusted manually or automatically. Disclosed herein is a lighting system which automatically adjusts the intensity of the work and/or drive lights as vehicle operation changes.

### BRIEF DESCRIPTION OF THE DRAWINGS

FIG. 1 illustrates an exemplary embodiment of a work vehicle which may utilize the invention;

FIG. 2 illustrates a schematic of an exemplary embodiment of the invention;

FIG. 3 illustrates an exemplary flowchart for the exemplary embodiment of FIG. 2;

FIG. 4 illustrates a schematic of an alternative exemplary embodiment of the invention;

FIG. 5 illustrates an exemplary flowchart for the exemplary embodiment of FIG. 4; and

FIG. 6 illustrates an exemplary embodiment of a monitor through which settings for vehicle light intensities may be chosen.

### DESCRIPTION OF THE PREFERRED EMBODIMENT

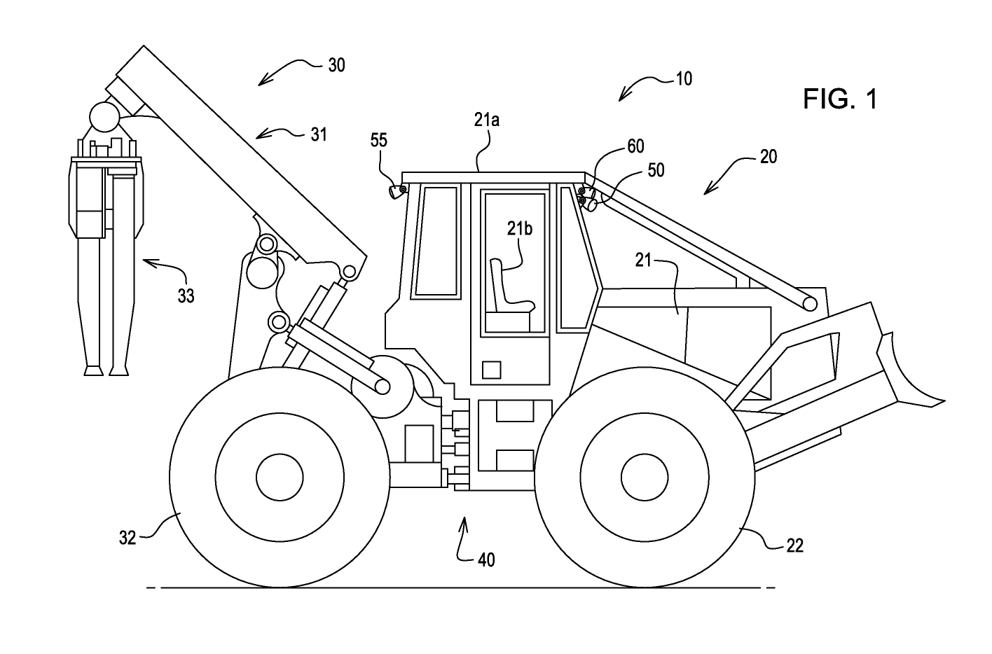

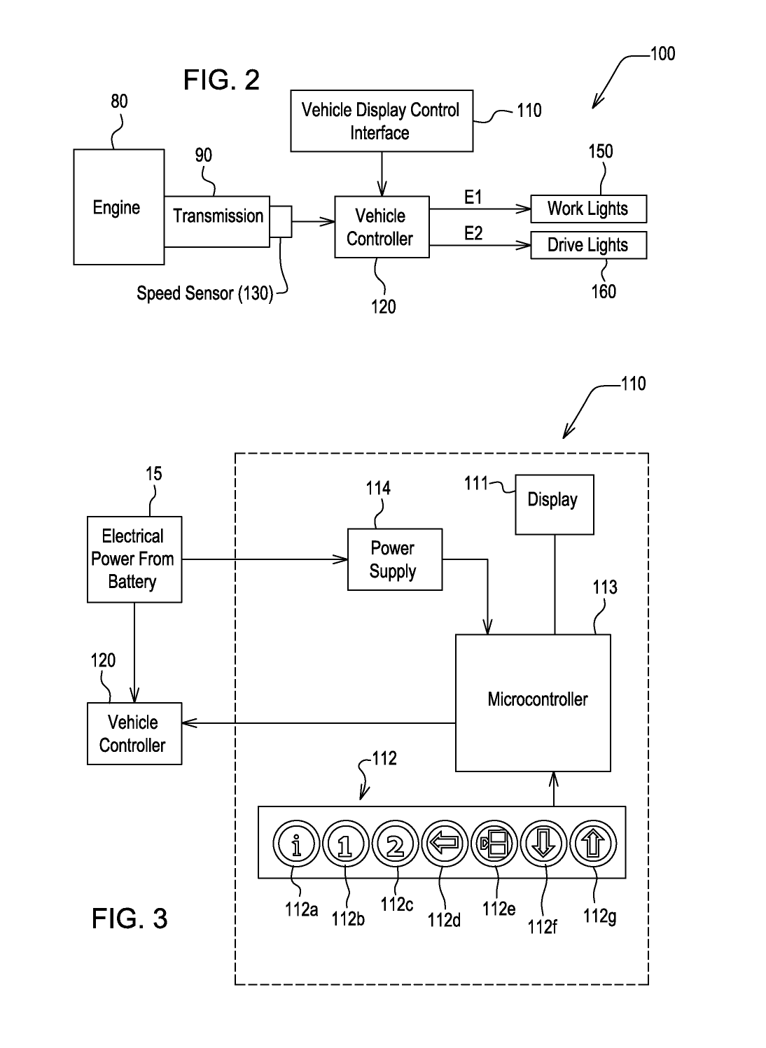

FIG. 1 illustrates an exemplary embodiment of a vehicle 10 which could make use of the invention. The particular embodiment illustrated is a log skidder 10 which may include: a front portion 20; a rear portion 30; and an articulation mechanism 40. The front portion 20 may include: a frame 21; a cab 21a; a seat 21b; front wheels 22; an engine 80 (see FIG. 2); and a transmission 90 (see FIG. 2). The rear portion 30 may include: a linkage system 31; rear wheels 32; and a work tool 33. The front and rear wheels 22, 32 are ground engaging and serve to propel the vehicle 10 along the surface of the earth. Also illustrated are conventional work lights 50 and drive lights 60 as well as rear lights 55.

FIG. 2 illustrates an exemplary schematic of a lighting system 100 of the vehicle 10, which may include: a lighting control interface such as, for example, a selection monitor or vehicle display control interface 110; a vehicle controller 120; a conventional speed sensor 130 which may be conventionally attached to a transmission 90 to detect a rotational speed at the transmission 90; LED (light emitting diode) work lights 150; and LED drive lights 160. As illustrated, the transmission 90 may be operably connected to the engine 80. The LED work and drive lights 150, 160 may replace the conventional work and drive lights 50, 60.

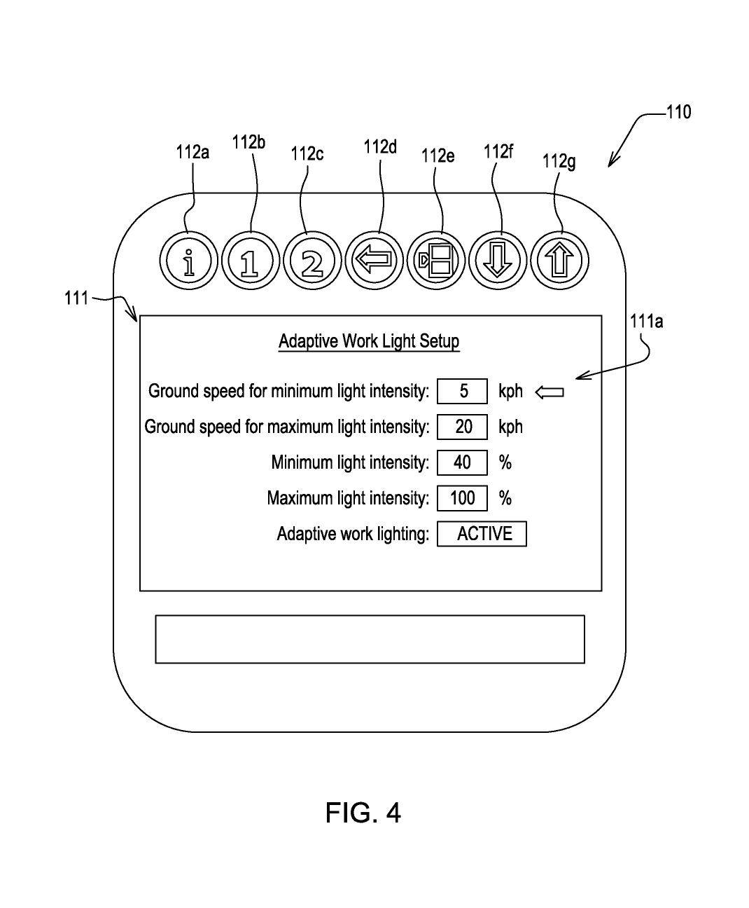

FIG. 3 illustrates an exemplary schematic of the vehicle display control interface 110 which may include: a display 111; operational selectors 112a-112g which, in this exemplary embodiment, includes: an information button 112a, a “1” button 112b, a “2” button 112c, a left arrow button 112d, a menu button 112e, a down arrow button 112f, and an up arrow button 112g; a microcontroller 113; and a power supply 114. The power supply 114 is, of course, connected to a battery 15. Any of the operational selectors 112a-112g may be activated when pressed. As illustrated, the operational selectors 112a-112g may be operably connected to the microcontroller 113 which may be in communication with the vehicle controller 120. The lighting system is powered via electrical power 15 which may be supplied from a conventional battery (not shown) when a conventional ignition (not shown) is turned on. Any of the operational selectors 112a-112g may be used to navigate to the exemplary menu 111a illustrated on the display 111 of FIG. 4 as well as to select and adjust the highlighted values for light adjustment parameters, which may include: ground speed for minimum light intensity, i.e., speed for low intensity value setting (“SLIS”); ground speed for maximum light intensity, i.e., speed for high intensity value setting (“SHIS); minimum light intensity, i.e., low intensity value setting (”LIS″); maximum light intensity, i.e., high intensity value setting(“HIS”); and adaptive work lighting which may have values of ACTIVE and INACTIVE. LIS may be defined as the minimum desired portion or percentage of the maximum available light intensity and SHIS may be defined as the maximum desired portion or percentage of the maximum available light intensity. Once selected and accepted, via the operational selectors 112a-112g, the highlighted values may be converted to electronic codes representative of those values by the microcontroller 113 and the codes may be communicated to the vehicle controller 120, via a CAN or LIN bus, where they may be conventionally stored.

It should be noted that the lighting control interface may be of any operable configuration including, but not necessarily limited to toggle switches, dials, slides, etc.

In operation, the speed sensor 130 may detect a speed and conventionally transmit a signal representative of the speed detected SD to the vehicle controller 120 which may convert the signal, via calculation or lookup table, to an intensity value (IV) where the intensity is a function of the values set for the light adjustment parameters. The controller 120 may then send electrical power to a light (i.e., a work light 150 or a drive light 160) in proportion to the IV. In doing so, the controller 120 may regulate the maximum electrical power available through a conventional pulse width modulation (PWM) process for efficiency. As illustrated in FIG. 2, the controller 120 may supply a first amount of electrical power (E1) to the work lights 150 while supplying a second amount of electrical (E2) to the drive lights 160 where E1 and E2 may be in accordance with the settings for the light adjustment parameters for each of the work lights 150 and drive lights 160. Thus, E1 and E2 may be independently determined and may be unequal. Further, the relative changes in E1 and E2 may be inversely proportional, i.e., E1 may increase as E2 decreases or vice versa.

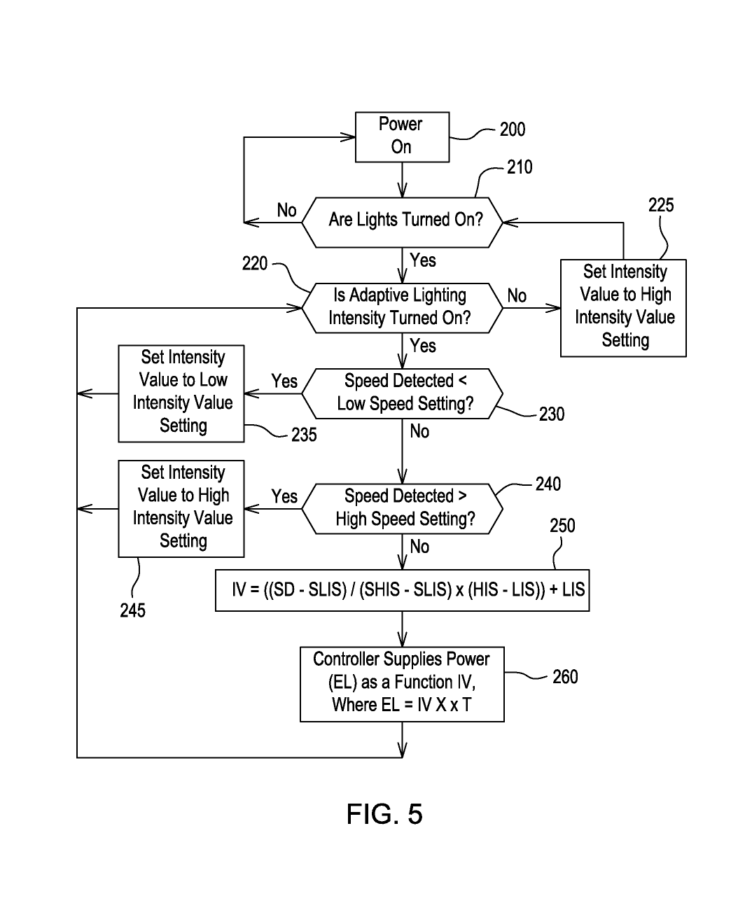

FIG. 5 illustrates an exemplary flowchart for the exemplary schematic of FIG. 2. As illustrated, the entire process begins at step 200 when power is supplied to the controller 120. As illustrated, if a light, i.e., a work light 150 or a drive light 160, is not turned on at step 210, nothing is done. Once a work light 150 or a drive light 160 is turned on at step 210, the controller 120 determines if adaptive lighting intensity (ALI) is active at step 220. If ALI is inactive at step 220, the controller 120 sets the IV to the high intensity setting (HIS) and returns to step 210. If ALI is active at step 220, the controller determines if the speed detected (SD) is lower than the speed for low intensity setting (SLIS) at step 230. If, at step 230 the SD is lower than the SLIS, the controller 120 sets the IV to the low intensity setting (LIS) and returns to step 220. If the SD is not less than the SLIS, the controller 120 determines if the speed detected is greater than the speed for high intensity setting (SH IS) at step 240. If the SD is greater than the SHIS, the controller 120 sets the IV to the high intensity setting (HIS) and returns to step 220. If, at step 240, the speed is not greater than the SHIS, the controller 120 may calculate IV as a function of the intensity adjustment settings. This calculation may be made according to the formula: IV=(((SD−SLIS)/(SHIS−SLIS))*(HIS−LIS))+LIS. Thus, higher SDs may result in higher IVs when SHIS is greater than SLIS. Under the steps described above, SLIS may always be less than SHIS.

It should be noted that the exemplary calculation for IV, described above and illustrated in FIG. 5, involves a ratio of speed differences. Thus, if the controller allowed the SHIS to be set at a lower value than the SLIS, the ratio may still result in a positive number or 0. Under these conditions higher SD's may result in lower IVs via the formula. However, under these circumstances, the controller may set the IV to the LIS at speeds greater than SHIS and set the IV to the HIS for speeds less than the SLIS.

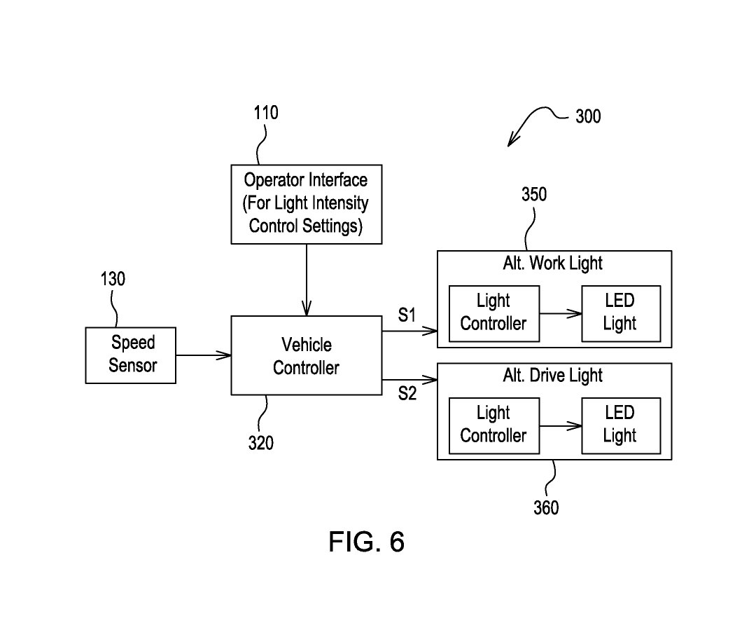

FIG. 6 illustrates an alternative exemplary schematic 300 for an alternative exemplary embodiment of the invention. As illustrated in FIG. 6, the alternative exemplary schematic 300 may differ from the exemplary schematic 100 of FIG. 2 in that, while the vehicle controller 320 may calculate the IV, it may not modulate the power. In the exemplary embodiment of FIG. 6, the controller 320 may calculate the IV and send, via CAN or LIN bus, a representative coded signal S to a self regulating light device (such as, for example, a self regulating or alternative work light 350 or drive light 360 with an integrated light controller) capable of receiving the representative coded signal S and supplying electrical power, via PWM, in an amount necessary to attain the desired IV, i.e., in accordance with the IV calculated. The alternative work and drive lights 350, 360 may be supplied with electrical power from the battery in a conventional manner. As illustrated in FIG. 6, the coded signal for the alternative work light 350 is S1 and the coded signal for the alternative drive light 360 is S2. The coded signals S1 and S2 may be electronic and may take any form recognizable by the corresponding alternative work light 350 and drive light 360. It should be noted that the values represented by S1 and S2 may have the same relationships to IV as the values represented by E1 and E2. Thus, the logic of the flowchart illustrated in FIG. 5 may apply to the exemplary alternative schematic illustrated in FIG. 6.

It should also be noted that, while the descriptions of the exemplary embodiments of the invention indicate that IV may change in proportion to a change in SD, the vehicle controller 120, 320 may be programmed such that IV remains constant within a predetermined speed range between SHIS and SLIS. Thus, in the exemplary embodiments described and illustrated above (see FIGS. 2 and 6) the intensity value may be set to LIS when SD is below SLIS, to a pre-set value between LIS and HIS when SD is between SLIS and SHIS, and at SHIS when SD is greater than SH IS. Other variations may also apply where a controller 120, 320 effects light intensity changes as a function of SD.

The vehicle controller 120, 320 may control light intensity as a function of rotational seat position in lighting systems which also include rear lights 55 when the seat 21b is equipped with a sensor for angular position (not shown) which is in communication with the vehicle controller 120, 320.

Having described the preferred embodiment, it will become apparent that various modifications can be made without departing from the scope of the invention as defined in the accompanying claims.

The invention claimed is:

1. A work vehicle lighting system, comprising:
a light;
a speed sensor for detecting a speed; and
a controller, the controller in communication with the speed sensor and operably connected with the light such that a light intensity is adjusted as a function of a speed detected.

2. The work vehicle lighting system of claim 1, wherein the speed detected is the speed of the work vehicle.

3. The work vehicle lighting system of claim 1, wherein the light intensity remains constant within a predetermined range of speeds detected.

4. The work vehicle of claim 1, wherein the light intensity changes proportionally with the speed detected.

5. The work vehicle lighting system of claim 1, wherein the light is a work light.

6. The work vehicle lighting system of claim 1, wherein the light is a drive light.

7. The work vehicle of claim 1, wherein the light intensity is adjusted by an adjusted amount of electrical power from the controller to the light.

8. The work vehicle of claim 1, wherein the controller is a vehicle controller which sends coded signals to the light which are representative of a light intensity adjusted as a function of speed.

9. The work vehicle of claim 8, wherein the light intensity is adjusted via a coded signal from the vehicle controller and an electrical power adjustment by the light.

10. A method of controlling intensity of a vehicle light on a vehicle having a speed sensor to detect a speed and a controller in communication with the speed sensor and operably connected with the light, the method comprising:
detecting a speed;
determining a desired light intensity as a function of the speed detected; and
effecting the desired light intensity.
